(19) United States
(12) Patent Application Publication
(10) Pub. No.: US 2012/0084224 A1
(43) Pub. Date: Apr. 5, 2012

(54) AUTOMATICALLY CREATED REPORT GENERATOR FOR MANAGING INFORMATION TECHNOLOGY SERVICE PROJECTS

(75) Inventors: Manisha D. Bhandar, Yorktown Heights, NY (US); Prahlad Chowdhury, Kolkata (IN); Maharshi H. Desai, Fairfax, VA (US); Pankaj Dhoolia, Uttar Pradesh (IN); Richard T. Goodwin, Dobbs Ferry, NY (US); Anca A. Ivan, San Jose, CA (US); Juhnyoung Lee, Yorktown Heights, NY (US); Pietro Mazzoleni, New York, NY (US); Rakesh Mohan, Cortlandt Manor, NY (US); Debdoot Mukherjee, Kolkata (IN); Sujoy Roy, Kolkata (IN); Ajay Satsangi, Charlotte, NC (US); Vibha S. Sinha, New Delhi (IN); Biplav Srivastava, Noida (IN)

(73) Assignee: INTERNATIONAL BUSINESS MACHINES CORPORATION, Armonk, NY (US)

(21) Appl. No.: 12/897,382

(22) Filed: Oct. 4, 2010

(51) Int. Cl. G06Q 10/00

(52) U.S. Cl. 705/342

(57) ABSTRACT

Reports to manage service projects may be generated by an automatically generated project report generator software tool. The project report generator software tool is automatically created from an object-based model of work products in a project, wherein the object-based model is executable by a machine and comprises a plurality of work product object and a recording of at least some relationships between the object, wherein each work product object represents a document that contains information about the service project. One or more reports can be generated by the project report generator software tool during the lifetime of the service project, wherein the report is generated using the object-based model and at least some of the information in documents represented in the object-based model.

### FIELD

The present disclosure relates to generating model-based reports related to Information Technology (IT) system and associated software application deployment.

### BACKGROUND

Large IT consulting service projects such as packaged software application projects can get very complex, many documents being created during the initial phases (e.g., process designs), and more documents being generated and maintained thereafter. A packaged application project is one that uses generic software assets that may be customized to meet a customer's individual needs. Thus far, the support for reporting facilities in projects that are in development or project phases have been limited. For example, different stakeholders of the projects such as project executives, process team lead, integration lead, consultants and subject matter experts get access to the information only when the documents associated with the projects are completed. There also is no real-time tracking on the information related to the projects, for example, no benchmarks against which a project can compare its progresses. Typically reports of the projects are built from information manually extracted from those documents. Those involved in projects spend a lot of time in seeking for inputs to be used for reports.

### BRIEF SUMMARY

A method and system for generating reports to manage service projects are provided. The method in one aspect may include creating an object-based model of work products in the service project. The object-based model is executable by a machine and comprises a plurality of work product objects and a recording of at least some relationships between the objects. Each work product object represents a document that contains information about the service project. The method may also include creating a project report generator software tool, wherein the project report generator software tool is created by using the object-based model. The method may further include generating reports from the project report generator software tool during the lifetime of the service project. The report is generated using the object-based model and at least some of the information in documents represented in the object-based model.

A system of generating reports to manage service projects, in one aspect, may include an object-based model of work products in the service project, wherein the object-based model is executable by a machine and comprises a plurality of work product objects wherein each work product object represents a document that contains information about the service project. A tool generator is operable to automatically generate computer executable code from the object-based model. A project report generator software tool may be automatically generated by the tool generator from the object-based model. The project report generator software tool is operable to generate one or more reports during the lifetime of the service project, wherein the report is generated using the object-based model and at least some of the information in documents represented in the object-based model.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 is a flow diagram illustrating a model-based reporting method in one embodiment of the present disclosure.

FIG. 2 is an architectural diagram illustrating functional components of the model-based project network in one embodiment of the present disclosure.

FIGS. 3A, 3B, 3C illustrate sample reports generated by the model-based report generator.

FIG. 4A illustrate an example of work product model.

FIG. 4B illustrates examples of a model based tool generator that uses a model to build a model-based project object editor and a model-based project report generator.

FIG. 4C illustrates an example of a work product template or report template form.

FIG. 5 illustrates an example of a computer system, in which the systems and methodologies of the present disclosure may be carried out or executed.

### DETAILED DESCRIPTION

The present disclosure, in one aspect, provides for model-based, object-level reports, and may utilize explicit definition of the model associated with various work product types involved in the design phase of a packaged application project. Work product types may include, for example, documents specifying requirements and installation steps for deploying a software project on a computer system. A model in the present disclosure refers to a representation of work products interpretable and executable by computers or machines. It may contain machine-readable representation of every piece of work products (e.g., title, sections such as process description, requirements, gaps, risks, notes, etc.) as objects and their attributes. In addition, a model may record relationships between different objects as well as attributes of the objects. It is often written in markup languages such as Extensible Markup Language (XML). Note the distinction between the model as a template and instances (instantiation of model with actual data values). A model may be used to build tools like Consultant Assistant™ from International Business Machines of Armonk, N.Y., which is used to process (create, edit, store, retrieve, print, etc.) work products for the project, and also generate reports as claimed in this application. “Model-based” refers to the use of such model of work products. For example, model-based tool or software may be a tool or software built on top of the model of work products. The tool can be used to process (create, edit, store, retrieve, print, etc.) work products and reports. In the present disclosure, the report generator tool is based on the model of work products.

The report generating of the present disclosure in another aspect uses model-based approaches to collecting real-time information on project documentation and also uses model-based information to build project benchmarks. Model-based information is stored in a structured manner for easy retrieval and use by different computer modules or components. Model-based information and creation and use of such information are described in detail in co-owned U.S. patent application Ser. No. 12/575,163 entitled MODELING AND LINKING DOCUMENTS FOR PACKAGED SOFTWARE APPLICATION CONFIGURATION, which disclosure is incorporated herein in its entirety by reference thereto. Using such methodology as disclosed in that application, an object-based model of work products may be created.

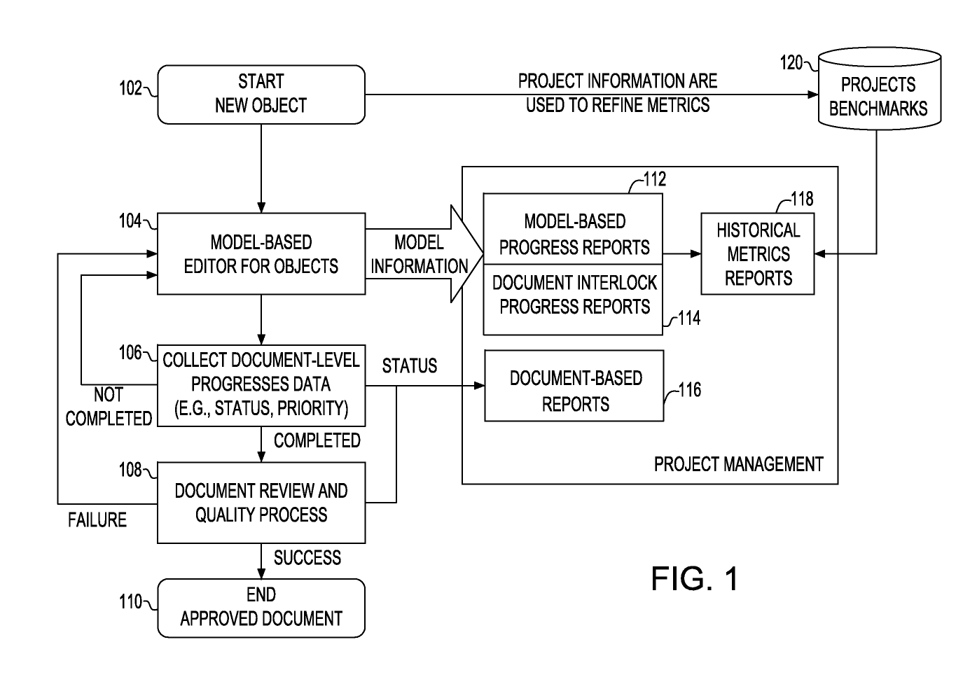

FIG. 1 is a flow diagram illustrating a model-based reporting method in one embodiment of the present disclosure. At 102, a new work product object is created, for example, as part of a new project or a new work product of an on-going or existing project. For example, a new work product object representing a work product document may be created from one or more work product objects selected from an existing repository of work product objects. A user may query a repository using user interface software and select objects to be included in the new work product. Objects in the repository may represent sections of a work product document. An example of a new work product object for packaged application practice may include Process Definition Document (PDD), Gap Document, Requirement Document or others. Examples of objects to be included in the new work product object may be Title, Description, Gaps, Requirements, Risks, Notes, which may be sections of the PDD doe. There may be separate documents for Gaps and Requirements providing more details and their attributes. So there may be links between PDD documents and the documents for the gaps and requirements sections.

At 104, a model-based editor for objects is used to edit the created new work product object. For instance, model of work products is used to build model-based work product editor tool like IBM's Consultant Assistant™ which may be used to process (create, edit, store, retrieve, print, etc.) work products for the project, and also generate reports. The information in the model-based editor is used to generate reports. For example, model-based progress reports 112, document interlock progress reports 114, historical metric reports 118 may be generated. Model-based progress reports 112 may be generated from the information on each reportable entities such as those processes captured through the model of work products. The processes may include create, edit, update, and other actions that manipulate the model. This information may be collected and displayed in report forms on a user interface of the model-based tool. The reports also can be stored in database, retrieved and printed as needed or desired.

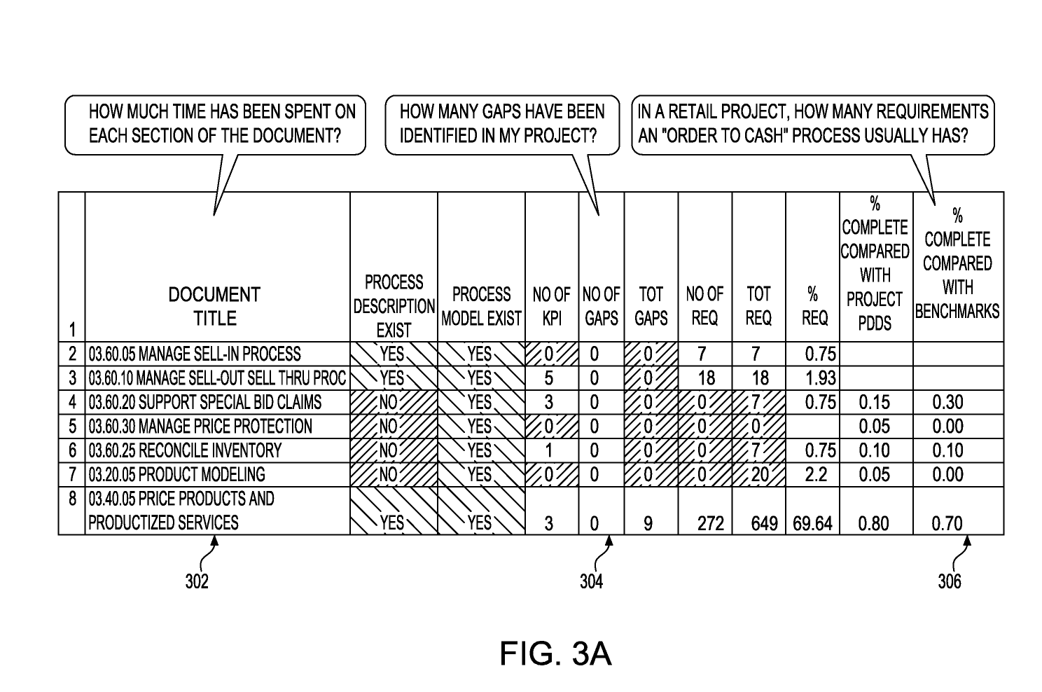

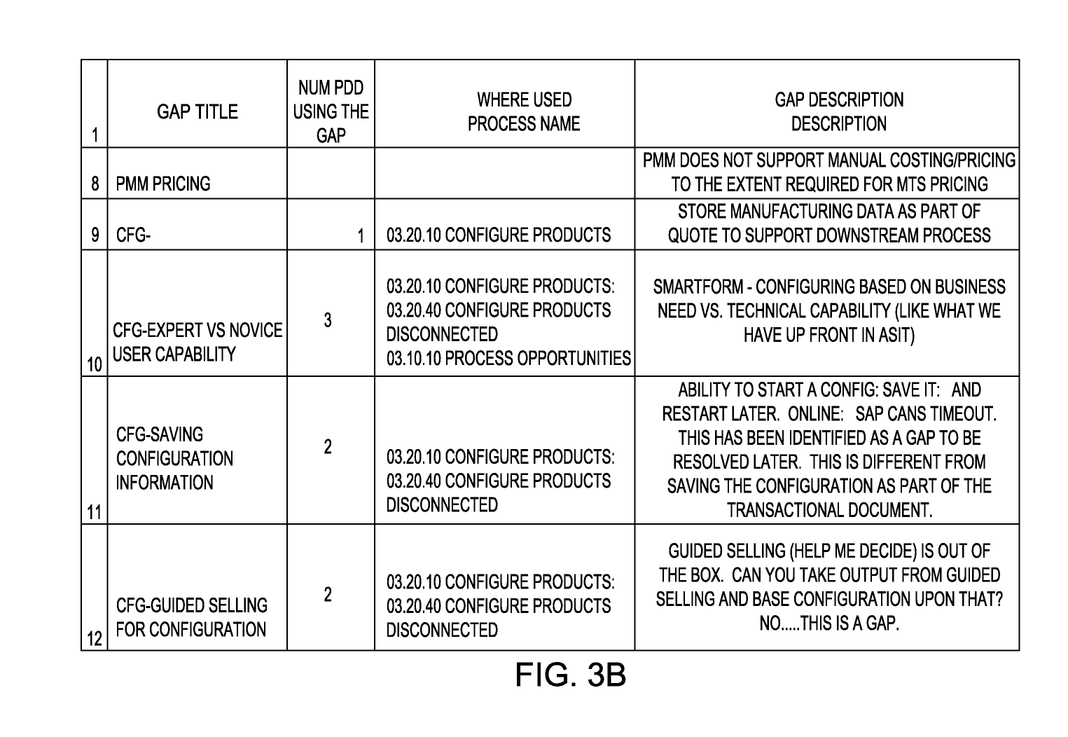

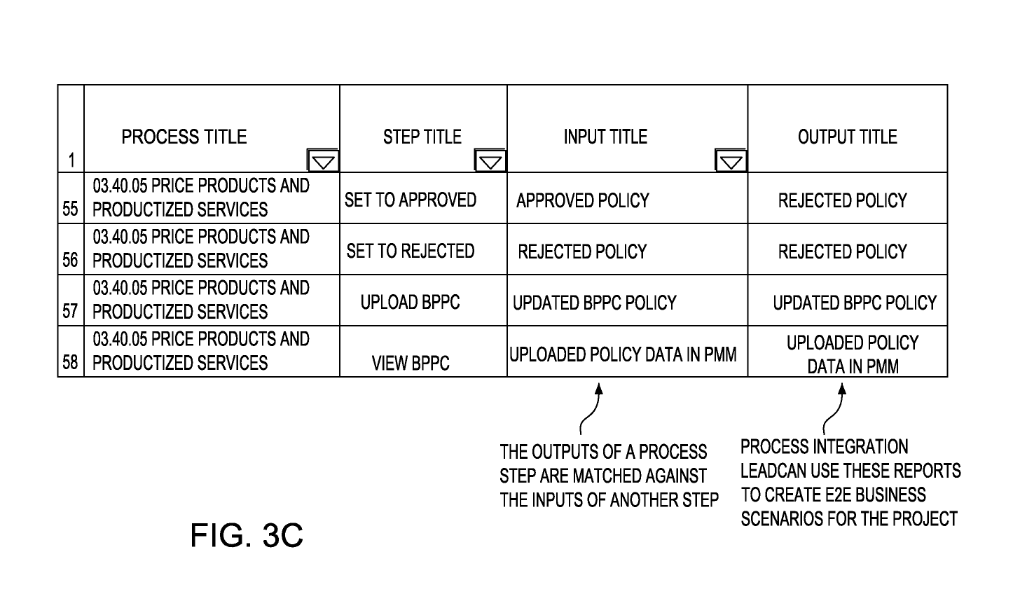

Item 114 shows “business process interlock reports”. These reports show relationships among different process scenarios in a project. For example, in a packaged application project, one or more consultants or the like may design a process scenario in the project scope. Each process scenario (e.g., Human Resource hiring scenario) may include multiple processes (e.g., job posting, candidate selection, candidate interview, and others) which are often executed sequentially or in parallel, and also with some conditions to support the scenario. In the present disclosure, this type of process execution structure is referred to as work flow. Processes are connected via their input and output. A sequence of process 1 and process 2 is often implemented by the output of process 1 being passed to process 2 as its input. In designing a process scenario, often the task is broken into multiple pieces by process and given to different teams. While each team makes progress with its process, the Process Integration Lead needs to understand how the progress in each process come along together—through “Process Interlock Report” which shows the status of each process definition and their input and output matched among processes in the scenario. An example of the interlock report is shown in FIG. 3C. Document interlock progress reports 114 may be generated by a model-based report generator of the present disclosure in one embodiment. For instance, the model-based report generator may use the data stored in the project object database, that is, work product objects, and project benchmark database to create project reports. The project object database stores instances of model objects (e.g., process, title, description, gaps, requirements, risks, notes, etc. in the database). The data is populated in report forms as shown in FIGS. 3A, B and C by the model-based project report generator.

Historical metric reports may be generated by using data stored in projects benchmarks repository 120 and comparing the data associated with the current model-based object. The benchmark data provides some detail values such as how many steps there are in the process in the best practice cases, e.g., 10. Then, the tool compares the current number of steps that are defined in this project (e.g., in blueprinting phase or design phase) against the benchmark number, and calculates the completion percentage in the column. For example, referring to the last two columns in FIG. 3A, each row in the table represents a process in the project scope. Each process includes a number of steps. Also a PDD is generated for each process in the Blueprinting (design) phase. The status of a PDD is determined by the number of steps in the process which was fully defined (completed) in the PDD. That defines the % of completion for each PDD. By comparing the number of the completed steps in this process for this project with that of the steps in the best-practice benchmark, one can calculate the % completion against the benchmark (the last column). The projects benchmarks repository 120 in turn may be refined using the current project information. For instance, data from the current project may be incorporated into the overall benchmark data to calculate new benchmark data.

At 106, information such as dates, status and others are collected from the model-based work product object. At 108, a reviewer may use the generated reports to find problems in the documents. At this point, the work product like PDD is generated from the tool in human-readable format like in Word from Microsoft Corp. of Redmond, Wash. A consultant or the like may manually review the documents and generate reports 116 manually, if needed or desired, for example, using tools such as Microsoft Excel®. At 110, the newly created work product object representing the document is approved.

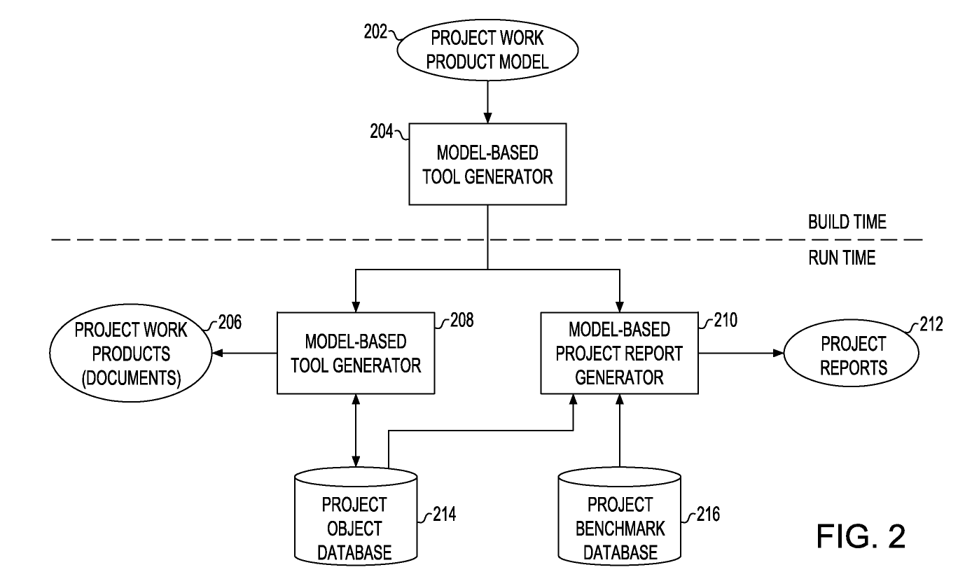

FIG. 2 is an architectural diagram illustrating functional components of the model-based reporting system in one embodiment of the present disclosure. A project work product model 202 is one of the work products in IT consulting service projects. It is a representation of work products interpretable and executable by computers or machines. It contains machine-readable representation of every piece of work products, e.g., title, sections such as process description, requirements, gaps, risks, notes, etc., as objects and their attributes. In addition, the model 202 records linking and relationships of different objects and attributes. It may be written in markup languages such as XML. There is a difference between the model as a template and instances (instantiation of model with actual data values). The model is used to build tools like Consultant Assistant™ which is used by consultants or the like to process (create, edit, store, retrieve, print, etc.) work products for the project, and also generate reports. Thus, as an example, a project work product model 202 may include objects such as extended markup language (XML) objects that are sections of content of a work product document.

A model-based tool generator 204 builds or generates a software tool 208 that can be used to perform operations such as create and modify on the objects.

The model-based report generation of the present disclosure utilizes the concept of model-driven architecture (MDA). Generally, MDA is a software design and engineering approach and provides a set of guidelines for structuring software expressed as models. It also provides a software development approach starting with a system functionality definition as a platform-independent model (PIM) in a domain-specific language (DSL). In the present disclosure, an example of a PIM is an XML model created by a user from his/her observation of some loose situation (e.g., shown in FIG. 2 at 202). This model serves as template. The initial model can be used to derive models computer can process by one or more model transformation operations. The PIM is translated into one or more platform-specific models (PSMs) that computers can run in corresponding platforms such as Web, .NET and Common Object Request Broker Architecture (CORBA). Briefly, .Net is a software framework from Microsoft™ that provides program codes such as library codes and a virtual machine; CORBA, a standard defined by the Object Management Group (OMG), allows separate pieces of software written in different computer languages and running on different computers to work together as an application or service. A PSM can be expressed in a programming language such as Java, C#, PHP, etc., which the platform can understand and execute.

Much of the work on MDA is centered on the automated tools for model transformation. An MDA tool may be used to develop, interpret, compare, align, measure, verify, and transform models. MDA tool may be used to generate code. The model-based tool generator 204 represents this aspect of the MDA tool. As an example, the user can create XML rendering which contain connoted model data (e.g., 202). Then, the MDA tool can derive from the XML rendering parts or all of the source code for the software system. In some cases, the user can provide a skeleton of the program source code in the form of a source code template where predefined tokens are then replaced with program source code parts during the code generation process. An example is Eclipse Modeling Framework (EMF, which is an Eclipse-based modeling framework and code generation facility for building tools and other applications based on a structured data model. From a model specification described in XMI, Unified Modeling Language (UML) or annotated Java, EMF™ provides tools and runtime support to produce a set of Java™ classes for the model, a set of adapter classes that enable viewing and command-based editing of the model, and a basic editor such as the model-based project object editor 208 and model-based project report generator 210.

The model-based project object editor 208 is used to create project work products 206. For instance, work product objects stored in a project objects database 214 may be selected, and/or updated, modified using the model-based project object editor 208 to create one or more project work products 206.

The model-based tool generator 204 also generates a software report generator module 210 that can create different types of reports. The model-based report generator 210 may use the data stored in the project object database 214, that is, work product objects, and project benchmark database 216 to create project reports 212. The project object database 214 stores instances of model objects (e.g., process, title, description, gaps, requirements, risks, notes, etc.) in the database. The data is populated in report forms as shown in FIG. 3A, 3B, 3C by the model-based project report generator 210.

FIGS. 3A, 3B, 3C illustrate sample reports generated by the model-based report generator 210. FIG. 3A shows a document progress status report. It shows a process-centric view. Reports 320 may be generated dynamically from the model-based tools shown in FIGS. 2 at 204, 208 and 210. Shown at 302 as an example, processes, one in each row, are the ones of interest for reporting, i.e., the processes in the scope of the project. Shown at 304, is the number of gaps identified for each process in the scope. This value, the number of gaps for each process, can be automatically populated from the model object database 214. The report also shows the comparison of the document (object) with similar ones created in other projects at 306.

FIG. 3B illustrates gap footprint report. This is Gap-oriented view of the status of the project. In the first column, each row represents a gap, i.e., the difference between what generic packaged application (e.g., an SAP application) software does and what the client really needs to support the client's process. The gaps are part the model of work product. As the tool is used to collect and store data instances of the gap objects, the project object database 214 stores the object. The report generator tool (FIG. 2, 210) can dynamically pull up the data and populate a report as shown in FIG. 3B.

FIG. 3C shows a process interlock report. These reports show relationships among different process scenarios in a project, and the status of each process definition and their input and output matched among the processes in the project scenario.

The report generator tool of the present disclosure allows for the automatic, dynamic, real-time generation of different reports, ones like shown in FIG. 3A, FIG. 3B and FIG. 3C. It should be understood that those figures only show a few example of the reports that may be generated. Other wide variety of reports showing different data and relationships are possible.

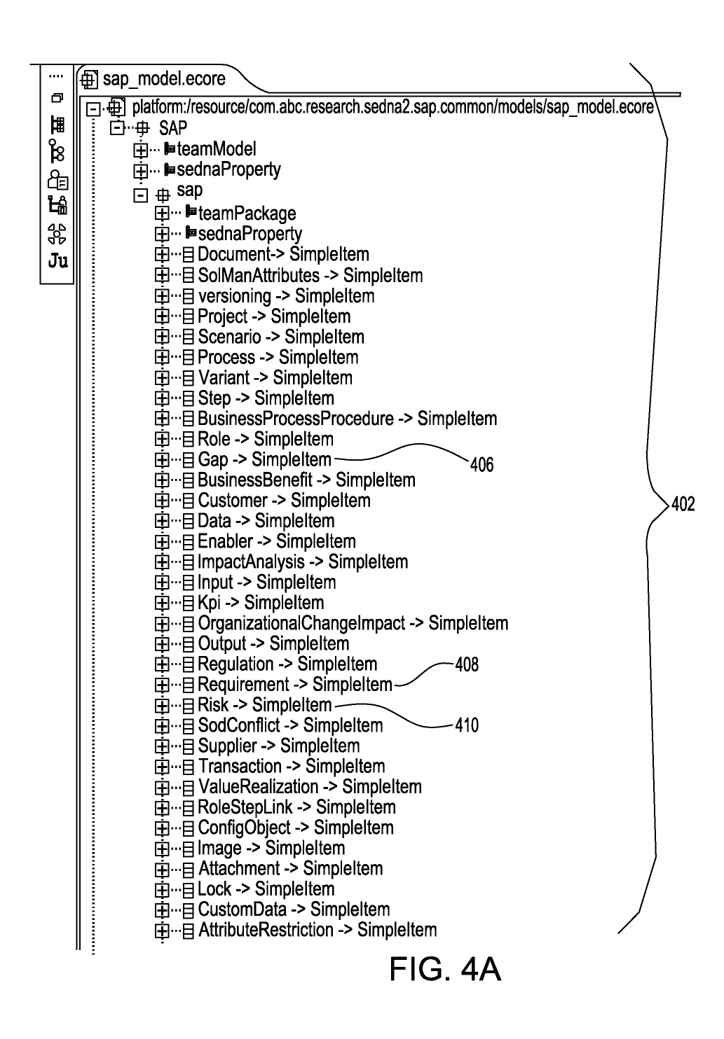

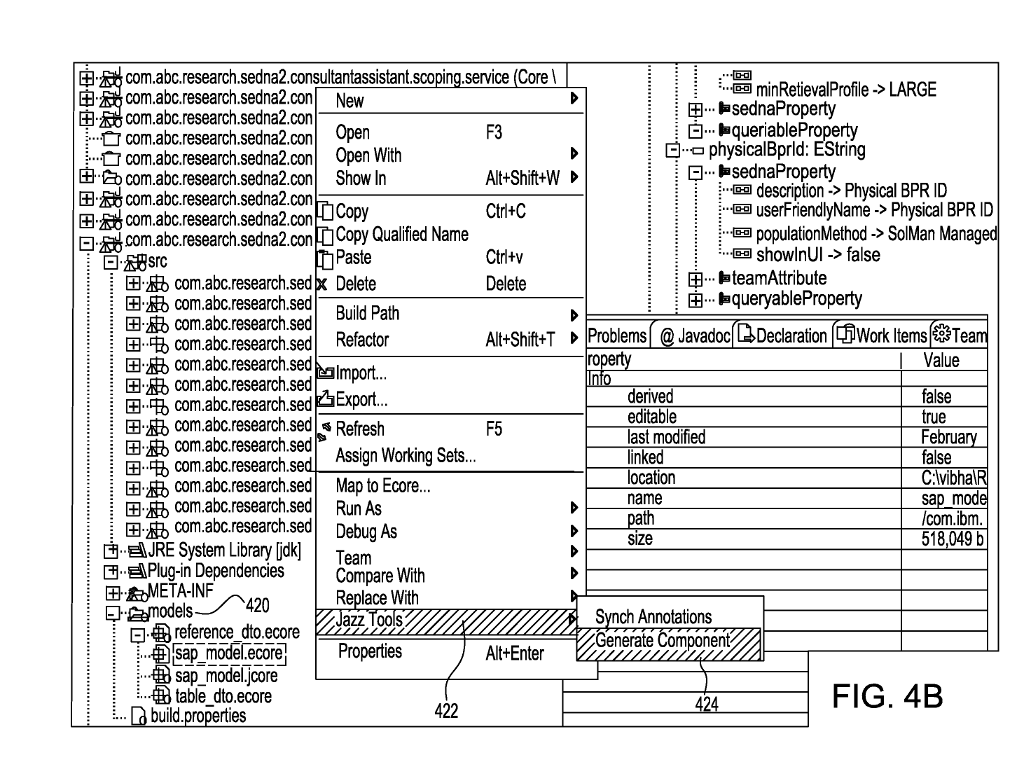

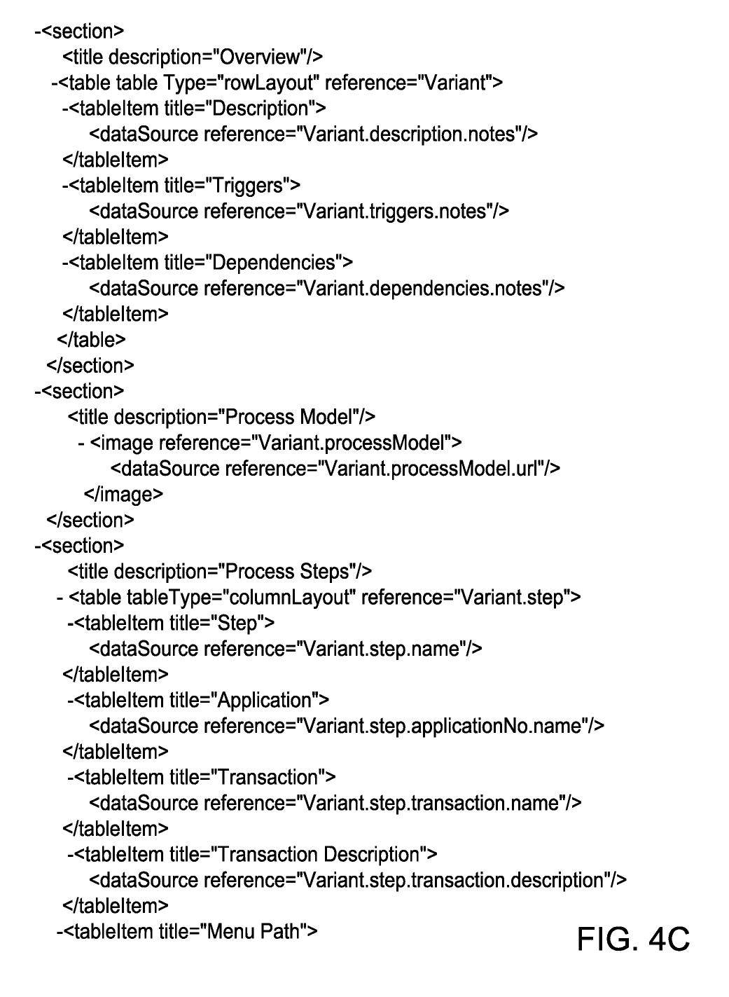

FIG. 4A illustrates an example of work product model, for example shown at 202, FIG. 2. The example work product model 402 is specified in XML. This is a representation of the XML file (known as ecore model) in an XML tool (Eclipse) providing a tree structure view of the XML file with exploration capabilities for human consumption of the XML file. Elements such as BusinessProcessProcedure, Gap 406, Requirement 408, Risk 410 may be used to generate reports related to the data of those elements.

FIG. 4B illustrates examples of a model based tool generator that uses a model to build a model-based project object editor and a model-based project report generator. In this example, an MDA tool (Eclipse) 422 is used to generate basic code (“Jazz Components”) for model-based project object editor as shown at 424. The MDA tool 422 in this example uses the work product model 420 to generate the basic code components. Programmers or the like may also refine the generated basic code to complete the building of the model-based project object editor and the model-based project report generator.

FIG. 4C illustrates an example of a work product template or report template form. The template in this example is shown in XML. Other formats may be used. The model-based project report generator of the present disclosure may populate the <dataSource> element of the XML shown in FIG. 4C with data instances of work product objects, for example, from the databases shown in FIG. 2 (214, 216).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

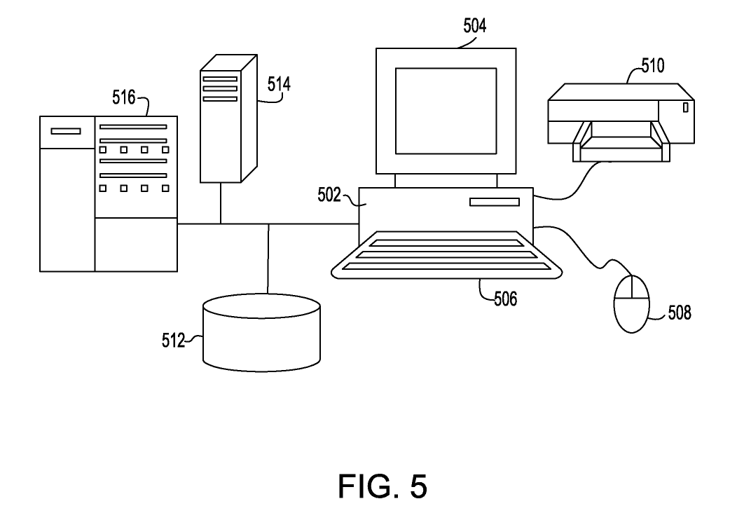

Referring now to FIG. 5, the systems and methodologies of the present disclosure may be carried out or executed in a computer system 502 that includes a processing unit, which houses one or more processors and/or cores, memory and other systems components (not shown expressly in the drawing) that implement a computer processing system, or computer that may execute a computer program product. The computer program product may comprise media, for example a hard disk, a compact storage medium such as a compact disc, or other storage devices, which may be read by the processing unit by any techniques known or will be known to the skilled artisan for providing the computer program product to the processing system for execution.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The computer processing system that carries out the system and method of the present disclosure may also include a display device such as a monitor or display screen 504 for presenting output displays and providing a display through which the user may input data and interact with the processing system, for instance, in cooperation with input devices such as the keyboard 506 and mouse device 508 or pointing device. The computer processing system may be also connected or coupled to one or more peripheral devices such as the printer 510, scanner (not shown), speaker, and any other devices, directly or via remote connections. The computer processing system may be connected or coupled to one or more other processing systems such as a server 510, other remote computer processing system 514, network storage devices 512, via any one or more of a local Ethernet, WAN connection, Internet, etc. or via any other networking methodologies that connect different computing systems and allow them to communicate with one another. The various functionalities and modules of the systems and methods of the present disclosure may be implemented or carried out distributedly on different processing systems (e.g., 502, 514, 516), or on any single platform, for instance, accessing data stored locally or distributedly on the network.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A method for generating reports to manage service projects, comprising:
creating an object-based model of work products in the service project, wherein the object-based model is executable by a machine and comprises a plurality of work product objects and a recording of at least some relationships between the objects, wherein each work product object represents a document that contains information about the service project;
creating a project report generator software tool, wherein the project report generator software tool is created by using the object-based model; and
generating reports from the project report generator software tool during the lifetime of the service project, wherein the report is generated using the object-based model and at least some of the information in documents represented in the object-based model.

2. The method of claim 1, wherein the work product objects include at least process, title, description, gaps, requirements, risks, and notes associated with the project.

3. The method of claim 1, wherein the project report generator software tool generates reports from data instances of the work product objects.

4. The method of claim 1, wherein the project report generator software tool generates reports from data instances of the work product objects and benchmark data corresponding to the work product objects.

5. The method of claim 1, wherein the project report generator software tool includes report template forms and populates the report template forms using data instances of the work product objects.

6. The method of claim 1, wherein the reports include process reports, gap reports, or process interlock reports, or combinations thereof.

7. A computer readable storage medium storing a program of instructions executable by a machine to perform a method of generating reports to manage service projects, comprising:
creating an object-based model of work products in the service project, wherein the object-based model is executable by a machine and comprises a plurality of work product objects and a recording of at least some relationships between the objects, wherein each work product object represents a document that contains information about the service project;
creating a project report generator software tool, wherein the project report generator software tool is created by using the object-based model; and
generating reports from the project report generator software tool during the lifetime of the service project, wherein the report is generated using the object-based model and at least some of the information in documents represented in the object-based model.

8. The computer readable storage medium of claim 7, wherein the work product objects include at least process, title, description, gaps, requirements, risks, and notes associated with the project.

9. The computer readable storage medium of claim 7, wherein the project report generator software tool generates reports from data instances of the work product objects.

10. The computer readable storage medium of claim 7, wherein the project report generator software tool generates reports from data instances of the work product objects and benchmark data corresponding to the work product objects.

11. The computer readable storage medium of claim 7, wherein the project report generator software tool includes report template forms and the project report generator software tool populates the report template forms using data instances of the work product objects.

12. The computer readable storage medium of claim 7, wherein the reports include process reports, gap reports, or process interlock reports, or combinations thereof.

13. A system of generating reports to manage service projects, comprising:
an object-based model of work products in the service project, wherein the object-based model is executable by a machine and comprises a plurality of work product objects wherein each work product object represents a document that contains information about the service project;
a tool generator operable to automatically generate computer executable code from the object-based model;
a project report generator software tool automatically generated by the tool generator from the object-based model, the project report generator software tool operable to generate one or more reports during the lifetime of the service project, wherein the report is generated using the object-based model and at least some of the information in documents represented in the object-based model.

14. The system of claim 13, wherein the work product objects include at least computer executable object representing process, title, description, gaps, requirements, risks, and notes associated with the project.

15. The system of claim 13, further including:
a project object database storing at least data instances associated with the object-based model of the work products, wherein the project report generator software tool generates reports from the data instances of the work product objects.

16. The system of claim 15, further including:
a project benchmark database storing benchmark data associated with the service project, wherein the project report generator software tool generates reports from the data instances of the work product objects and the benchmark data corresponding to the work product objects.

17. The system of claim 16, wherein the project report generator software tool includes report template forms and the project report generator software tool populates the report template forms using the data instances of the work product objects.

18. The system of claim 13, wherein the reports include process reports, gap reports, or process interlock reports, or combinations thereof.
